(19) United States
(12) Patent Application Publication
(10) Pub. No.: US 2021/0024408 A1
(43) Pub. Date: Jan. 28, 2021

(54) POROUS GLASS MEMBER

(71) Applicant: NIPPON ELECTRIC GLASS CO., LTD., Otsu-shi, Shiga (JP)

(72) Inventor: Masato TSUJIGUCHI, Otsu-shi (JP)

(21) Appl. No.: 17/042,972

(22) PCT Filed: Jun. 11, 2019
(86) PCT No.: PCT/JP2019/023090

§ 371 Date: Sep. 29, 2020

(30) Foreign Application Priority Data
Jun. 25, 2018 (JP) 2018-119625

(51) Int. Cl. C03C 11/00; C03C 3/06

(52) U.S. Cl. CPC C03C 11/005; C03C 2201/40; C03C 2201/32; C03C 3/061

(57) ABSTRACT

Provided is a porous glass member less likely to crack during production. A porous glass member has a porosity of 10 to 85% and contains, in terms of % by mass, 80 to below 100% SiO₂, over 0 to 10% ZrO₂, and 0 to 10% Al₂O₃.

### TECHNICAL FIELD

The present invention relates to porous glass members.

### BACKGROUND ART

Porous glass has a sharp pore distribution and a large specific surface area and also has thermal resistance and organic solvent resistance and, therefore, its use in a wide range of applications, including a separation membrane, a diffuser tube, an electrode material, and a catalyst carrier, is recently under consideration. Porous glass is produced by thermally treating a glass base material made of borosilicate glass to separate it into two phases: a silica-rich phase and a boron oxide-rich phase, removing the boron oxide-rich phase with an acid, then washing the silica-rich phase with water or the like, and then drying the silica-rich phase (see, for example, Patent Literature 1).

### CITATION LIST

### Patent Literature

### [PTL 1]

### JP-B2-4951799

### SUMMARY OF INVENTION

### Technical Problem

However, porous glass often cracks during production and is therefore difficult to produce into a desired shape.

In view of the above, the present invention has an object of providing a porous glass member less likely to crack during production.

### Solution to Problem

The inventor repeated various experiments and finally found that porous glass containing ZrO₂ often cracked during drying in the course of production and the cracking was caused by stress (capillary force) produced when water present in the pores volatilized.

A porous glass member according to the present invention has a porosity of 10 to 85% and contains, in terms of % by mass, 80 to below 100% SiO₂, over 0 to 10% ZrO₂, and 0 to 10% Al₂O₃. When the porosity is controlled to no more than 80%, the proportion of pores in the porous glass member is small and the capillary force responsible for the cracking can be made small, so that the porous glass member becomes less likely to crack. Furthermore, since the porous glass member contains ZrO₂ as an essential component, its weather resistance is likely to increase. The “porosity” can be calculated by the following equation.

Porosity=(volume of pores)/((volume of pores)+(volume of the skeleton of the porous glass member))

The porous glass member according to the present invention preferably has a median value of a porous distribution of 1 to 100 nm.

The porous glass member according to the present invention preferably has an aspect ratio of 2 to 1000. The aspect ratio can be calculated by the following equation.

Aspect ratio=(base area of the porous glass member)^{1/2}/(thickness of the porous glass member)

### Advantageous Effects of Invention

The present invention enables provision of a porous glass member less likely to crack during production.

### DESCRIPTION OF EMBODIMENTS

A description will be given of a porous glass member according to the present invention.

The porous glass member according to the present invention has a porosity of 10 to 85%, preferably 20 to 80%, more preferably 30 to 75%, and particularly preferably 40 to 70%. If the porosity is too small, the porous glass member is difficult to use as a separation membrane, a diffuser tube, an electrode material, a catalyst carrier, and so on. On the other hand, if the porosity is too large, the proportion of pores in the porous glass member is excessively increased and the capillary force responsible for cracking is large, so that the porous glass member is likely to crack. The porosity can be adjusted by the composition of a glass base material for the porous glass member, thermal treatment conditions, acid treatment conditions, alkali treatment conditions, and so on.

The porous glass member according to the present invention contains, in terms of % by mass, 80 to below 100% SiO₂, over 0 to 10% ZrO₂, and 0 to 10% Al₂O₃. The following description is given of the reasons why the content of each component is specified as above. In the following description of the respective contents of components, “%” refers to “% by mass” unless otherwise specified.

SiO₂ is a major component that forms the skeleton of the porous glass member and a component that increases the weather resistance. The content of SiO₂ is 80 to below 100%, preferably 85 to 99%, and particularly preferably 88 to 98%. If the content of SiO₂ is too small, the weather resistance tends to decrease. On the other hand, if the content of SiO₂ is too large, the mechanical strength is likely to decrease.

ZrO₂ is a component that increases the weather resistance. The content of ZrO₂ is over 0 to 10%, preferably 1 to 8%, and particularly preferably 2 to 5%. If the content of ZrO₂ is too small, the weather resistance tends to decrease. On the other hand, if the content of ZrO₂ is too large, the mechanical strength is likely to decrease.

Al₂O₃ is a component that increases the mechanical strength. The content of Al₂O₃ is 0 to 10%, preferably 1 to 8%, and particularly preferably 2 to 5%. If the content of Al₂O₃ is too large, the weather resistance is likely to decrease.

The porous glass member may contain, in addition to the above components, various components in a range not impairing the effects of the invention. For example, the porous glass member may contain, B₂O₃, Na₂O, K₂O, RO (where R represents at least one selected from among Mg, Ca, Sr, and Ba), TiO₂, La₂O₃, Ta₂O₅, TeO₂, Nb₂O₅, Gd₂O₃, Y₂O₃, Eu₂O₃, Sb₂O₃, SnO₂, P₂O₅, and Bi₂O₃, each preferably in a range of 5% or less, more preferably 3% or less, and particularly preferably 1% or less.

The porous glass member according to the present invention preferably has a median value of a pore distribution of 1 to 100 nm, more preferably 2 to 90 nm, and particularly preferably 5 to 80 nm. If the median diameter value of the pore distribution is too small, the capillary force responsible for cracking is large, so that the porous glass member is likely to crack. On the other hand, if the median value of the pore distribution is too large, the porous glass member is difficult to use as a separation membrane, a diffuser tube, an electrode material, a catalyst carrier, and so on. The pores have various shapes, such as spherical, approximately ellipsoidal, and tubular shapes.

The porous glass member according to the present invention preferably has an aspect ratio of 2 to 1000 and particularly preferably 5 to 500. If the aspect ratio is too small or too large, the porous glass member is difficult to handle.

The base area and thickness of the porous glass member may be appropriately adjusted to give the above aspect ratio. For example, the base area is preferably 1 to 1000 mm² and particularly preferably 5 to 500 mm² and the thickness is preferably 0.1 to 1 mm and particularly preferably 0.2 to 0.5 mm.

Next, a description will be given of a method for producing the porous glass member according to the present invention.

First, a glass base material for the porous glass member is prepared in the following manner.

Glass raw materials are formulated to give a glass composition containing, in terms of % by mass, 40 to 80% SiO₂, over 0 to 40% B₂O₃, over 0 to 20% Na₂O, over 0 to 10% ZrO₂, 0 to 5% Al₂O₃, and 0.5 to 20% RO (where R represents at least one selected from among Mg, Ca, Sr, and Ba) and having a mass ratio of Na₂O/B₂O₃ of 0.25 to 0.5. The following description is given of the reasons why the content of each component is specified as above. In the following description of the respective contents of components, “ o” refers to “% by mass” unless otherwise specified.

SiO₂ is a component that forms a glass network. The content of SiO₂ is 40 to 80%, preferably 45 to 75%, more preferably 50 to 70%, and particularly preferably 52 to 65%. If the content of SiO₂ is too small, the weather resistance and mechanical strength tend to decrease. In addition, the porosity tends to be large, so that the porous glass member is likely to crack. On the other hand, if the content of SiO₂ is too large, phase separation is less likely to occur. In addition, the porosity tends to be small, so that the porous glass member is difficult to use as a separation membrane, a diffuser tube, an electrode material, a catalyst carrier, and so on.

B₂O₃ is a component that forms a glass network and promotes phase separation. The content of B₂O₃ is over 0 to 40%, preferably 10 to 30%, and particularly preferably 20 to 25%. If the content of B₂O₃ is too small, the above effects are difficult to achieve. On the other hand, if the content of B₂O₃ is too large, the weather resistance is likely to decrease.

Na₂O is a component that decreases the melting temperature to improve meltability and also a component that promotes phase separation. The content of Na₂O is over 0 to 20%, preferably 3 to 10%, and particularly preferably 4 to 8%. If the glass base material is free of Na₂O, the above effects are difficult to achieve. On the other hand, if the content of Na₂O is too large, phase separation is less likely to occur contrariwise.

The ratio Na₂O/B₂O₃ is 0.25 to 0.5, preferably 0.28 to 0.4, and particularly preferably 0.3 to 0.35. If the ratio Na₂O/B₂O₃ is too small or too large, a boron oxide-rich phase is difficult to be removed in a later-described process for removing the boron oxide-rich phase with an acid.

ZrO₂ is a component that increases the mechanical strength. The content of ZrO₂ is over 0 to 10%, preferably 4 to 8%, and particularly preferably 5 to 7%. If the content of ZrO₂ is too small, the above effect is difficult to achieve. On the other hand, if the content of ZrO₂ is too large, devitrification is likely to occur and phase separation is less likely to occur.

Al₂O₃ is a component that increases the mechanical strength. The content of Al₂O₃ is 0 to 5%, preferably 1 to 4.5%, and particularly preferably 2 to 4%. If the content of Al₂O₃ is too large, phase separation is less likely to occur.

RO (where R represents at least one selected from among Mg, Ca, Sr, and Ba) is a component that increases the content of ZrO₂ in a silica-rich phase and increases the weather resistance. The content of RO (i.e., the total content of MgO, CaO, SrO, and BaO) is 0 to 20%, preferably 0.5 to 19%, more preferably 1 to 17%, still more preferably 3 to 15%, yet still more preferably 4 to 13%, and particularly preferably 5 to 10%. If the content of RO is too large, phase separation is less likely to occur. The content of each of MgO, CaO, SrO, and BaO is 0 to 20%, preferably 0.5 to 19%, more preferably 1 to 17%, still more preferably 3 to 15%, yet still more preferably 4 to 13%, and particularly preferably 5 to 10%. Of these, CaO is preferably used in view of its particularly large effect of increasing the weather resistance.

The glass base material for the porous glass member may contain, in addition to the above components, the following components.

K₂O is a component that decreases the melting temperature to improve meltability and also a component that promotes phase separation. The content of K₂O is preferably 0 to 20%, more preferably 3 to 10%, and particularly preferably 4 to 8%. If the content of K₂O is too large, phase separation is less likely to occur contrariwise.

ZnO is a component that increases the content of ZrO₂ in a silica-rich phase and increases the weather resistance. The content of ZnO is preferably 0 to 20%, more preferably 0 to 10%, and particularly preferably 0 to below 3%. If the content of ZnO is too large, phase separation is less likely to occur.

The glass base material for the porous glass member may contain, in addition to the above components, various components in a range not impairing the effects of the invention. For example, the glass base material may contain TiO₂, La₂O₃, Ta₂O₅, TeO₂, Nb₂O₅, Gd₂O₃, Y₂O₃, Eu₂O₃, Sb₂O₃, SnO₂, P₂O₅, and Bi₂O₃, each preferably in a range of 15% or less, more preferably 10% or less, particularly preferably 5% or less, and in a range of 30% or less in total content.

Next, the glass batch obtained by the formulation is melted at 1300 to 1500° C. for 4 to 12 hours. Subsequently, the molten glass is formed into a platy shape and then annealed at 400 to 600° C. for 10 minutes to 10 hours, thus obtaining a glass base material. The shape of the obtained glass base material is not particularly limited, but is preferably a platy shape having a rectangular or circular surface figure. In order to make the obtained glass base material into a desired shape, the glass base material may be subjected to processing, such as cutting or polishing. Furthermore, the glass base material may be continuously produced in a refractory furnace. The method for melting the glass and the method for forming the glass are not limited to the above methods.

The obtained glass base material preferably has an aspect ratio of 2 to 1000 and particularly preferably 5 to 500. If the aspect ratio is too small, this creates a large difference in the rate of removal of a boron oxide-rich phase between the surface and inside of the glass base material in the process for removing the boron oxide-rich phase with an acid, so that stress is likely to be produced and the porous glass member is therefore likely to crack. On the other hand, if the aspect ratio is too large, the glass base material is difficult to handle.

The base area and thickness of the obtained glass base material may be appropriately adjusted to give the above aspect ratio. For example, the base area is preferably 1 to 1000 mm² and particularly preferably 5 to 500 mm² and the thickness is preferably 0.1 to 1 mm and particularly preferably 0.2 to 0.5 mm.

Next, the obtained glass base material is thermally treated to separate it into two phases: a silica-rich phase and a boron oxide-rich phase. The thermal treatment temperature is preferably 500 to 800° C. and particularly preferably 600 to 700° C. If the thermal treatment temperature is too high, the glass base material softens and is therefore less likely to obtain a desired shape. On the other hand, if the thermal treatment temperature is too low, the glass base material is less likely to cause phase separation. The thermal treatment time is preferably ten minutes or more, more preferably an hour or more, and particularly preferably three hours or more. If the thermal treatment time is too short, the glass base material is less likely to cause phase separation. The upper limit of the thermal treatment time is not particularly limited. However, even if the glass base material is thermally treated for a long time, phase separation does not progress beyond a certain level. Therefore, the thermal treatment time is actually not more than 180 hours.

Next, the glass base material separated into two phases is immersed into an acid to remove the boron oxide-rich phase and then washed with ion-exchange water or the like. Thereafter, the glass base material is dried by volatilizing water by natural drying or other methods, thus obtaining a porous glass member. The acid that can be used is hydrochloric acid or nitric acid. These acids may be used in mixture. The concentration of the acid is preferably 0.1 to 5 N and particularly preferably 0.5 to 3 N. The time for immersion in the acid is preferably an hour or more, more preferably 10 hours or more, and particularly preferably 20 hours or more. If the time for immersion is too short, a porous glass member is less likely to be obtained. The upper limit of the time for immersion is not particularly limited, but it is actually not more than 100 hours. The temperature during immersion is preferably 20° C. or higher, more preferably 25° C. or higher, and particularly preferably 30° C. or higher. If the temperature during immersion is too low, a porous glass member is less likely to be obtained. The upper limit of the temperature during immersion is not particularly limited, but it is actually not higher than 95° C.

In the process for thermally treating the glass base material to separate it into two phases: a silica-rich phase and a boron oxide-rich phase, a silica-containing layer (a layer containing silica in a content of approximately 80% by mass or more) tends to be formed in the uppermost portion of the surface of the glass base material. The silica-containing layer is difficult to be removed with an acid. Therefore, if a silica-containing layer has been formed, the glass base material separated into phases is cut and polished to remove the silica-containing layer and then immersed into an acid. Thus, the boron oxide-rich phase can be more easily removed.

Furthermore, it is preferred to remove residual ZrO₂ colloid and SiO₂ colloid in the pores of the obtained porous glass member. The following description is given of a method for removing ZrO₂ colloid and a method for removing SiO₂ colloid. However, the methods are not limited to the following.

ZrO₂ colloid can be removed, for example, by sulfuric acid. The concentration of sulfuric acid is preferably 0.1 to 5 N and particularly preferably 1 to 5 N. The time for immersion in sulfuric acid is preferably an hour or more and particularly preferably 10 hours or more. If the time for immersion is too short, ZrO₂ colloid is less likely to be removed. The upper limit of the time for immersion is not particularly limited, but it is actually not more than 100 hours. The temperature during immersion is preferably 20° C. or higher, more preferably 25° C. or higher, and particularly preferably 30° C. or higher. If the temperature during immersion is too low, ZrO₂ colloid is less likely to be removed. The upper limit of the temperature during immersion is not particularly limited, but it is actually not higher than 95° C. When ZrO₂ colloid is removed, the porosity of the porous glass member tends to increase.

SiO₂ colloid can be removed, for example, by an alkaline aqueous solution. Examples of the alkali that can be used include sodium hydroxide and potassium hydroxide. These alkalis may be used in mixture. The time for immersion in the alkaline aqueous solution is preferably 10 minutes or more and particularly preferably 30 minutes or more. If the time for immersion is too short, SiO₂ colloid is less likely to be removed. The upper limit of the time for immersion is not particularly limited, but it is actually not more than 100 hours. The temperature during immersion is preferably 15° C. or higher and particularly preferably 20° C. or higher. If the temperature during immersion is too low, SiO₂ colloid is less likely to be removed. The upper limit of the temperature during immersion is not particularly limited, but it is actually not higher than 95° C. When SiO₂ colloid is removed, the porosity of the porous glass member tends to increase.

### EXAMPLES

Hereinafter, the present invention will be described with reference to examples, but is not limited to these examples.

Table 1 shows examples (Sample Nos. 1 to 5) of the present invention.

### Table 1

TABLE 1

| | | No. 1 | No. 2 | No. 3 | No. 4 | No. 5 |
|---|---|---|---|---|---|---|
| Glass | glass composition | | | | | |
| base | (% by mass) | | | | | |
| material | SiO₂ | 60 | 57 | 55 | 53 | 53 |
| | B₂O₃ | 17.5 | 19.8 | 21.3 | 22.9 | 22.9 |
| | Na₂O | 5.5 | 6.2 | 6.7 | 7.1 | 7.1 |
| | ZrO₂ | 6 | 6 | 6 | 6 | 6 |
| | Al₂O₃ | 3 | 3 | 3 | 3 | 3 |
| | CaO | 8 | 8 | 8 | 8 | 8 |
| Porous | glass composition | | | | | |
| glass | (% by mass) | | | | | |
| member | SiO₂ | 92.9 | 93.1 | 93.3 | 91.4 | 95.6 |
| | ZrO₂ | 3.1 | 3.5 | 3.7 | 4.8 | 2.6 |
| | Al₂O₃ | 4 | 3.4 | 3 | 3.4 | 1.8 |
| | median value (nm) of | 58 | 70 | 78 | 5 | 10 |
| | pore distribution | | | | | |
| | porosity | 68 | 77 | 78 | 25 | 40 |
| | cracking during drying | good | good | good | good | good |

Raw materials formulated to give each of the compositions in the table were put into a platinum crucible and then melted therein at 1400° C. for six hours. In melting the glass batch, molten glass was stirred using a platinum stirrer to homogenize it. Next, the molten glass was poured onto a carbon sheet to form it into a platy shape and then annealed at 500° C. for 30 minutes, thus obtaining a glass base material.

The obtained glass base material was thermally treated in an electric furnace at 675° C. for 24 hours to separate it into phases. The glass base material separated into phases was cut and polished to a size of 5 mm×5 mm×0.5 mm (thickness). Next, the glass base material was immersed into 1 N nitric acid (at 90° C.) for 48 hours, then washed with ion-exchange water, and then allowed to stand in the atmosphere for 24 hours to volatilize water, thus obtaining a porous glass member. As for Samples Nos. 1 to 3 and 5, the obtained porous glass member was immersed into 3 N sulfuric acid (at 95° C.) for 48 hours to remove ZrO₂ colloid, then washed with ion-exchange water, and then allowed to stand in the atmosphere for 24 hours to volatilize water. As for Samples Nos. 1 to 3, the porous glass member from which ZrO₂ colloid was removed was immersed into 0.5 N sodium hydroxide aqueous solution (at 25° C.) for 3.5 hours to remove SiO₂ colloid, washed with ion-exchange water, and then allowed to stand in the atmosphere for 24 hours to volatilize water.

When the surfaces of the obtained porous glass members were observed with an FE-SEM (SU-8220 manufactured by Hitachi, Ltd.), all the glass members had a skeleton structure based on spinodal phase separation. Furthermore, the obtained porous glass members were evaluated in terms of composition, the median value of the pore distribution, porosity, and cracking during drying.

The composition was measured with an energy dispersive X-ray analyzer (EX-250 manufactured by Horiba, Ltd.).

The median value of the pore distribution and the porosity were measured with a pore distribution measurement device (QUADRASORB SI manufactured by Quantachrome Instruments). Note that the porosity was determined from the volume (cm³) of pores and the volume (cm³) of the skeleton of the porous glass member according to the above-described equation and the density of the skeleton of the porous glass member, 2.5 (g/cm³), was used in calculating the volume (cm³) of the skeleton of the porous glass member.

With respect to cracking during drying, porous glass members not confirmed to have cracked during drying were evaluated as “good” and porous glass members confirmed to have cracked during drying were evaluated as “poor”.

Samples Nos. 1 to 5, which are examples of the present invention, were not confirmed to have cracked during drying.

### INDUSTRIAL APPLICABILITY

The porous glass member according to the present invention is suitable for a wide range of applications, including a separation membrane, a diffuser tube, an electrode material, and a catalyst carrier.

1. A porous glass member having a porosity of 10 to 85% and containing, in terms of % by mass, 80 to below 100% SiO₂, over 0 to 10% ZrO₂, and 0 to 10% Al₂O₃.

2. The porous glass member according to claim 1, having a median value of a pore distribution of 1 to 100 nm.

3. The porous glass member according to claim 1, having an aspect ratio of 2 to 1000.
